(19) United States
(12) Patent Application Publication
(10) Pub. No.: US 2005/0091143 A1
(43) Pub. Date: Apr. 28, 2005

(54) Contract circle-closer

(76) Inventors: Guenter Schmidt, Neunkirchen (DE); Antonia Gross, Leimen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/695,428

(22) Filed: Oct. 28, 2003

(51) Int. Cl. G06F 17/60

(52) U.S. Cl. 705/37

(57) ABSTRACT

Generating contract documents in a recurring contracting environment comprises receiving a contract renewal indication, generating a bid invitation having a plurality of offered terms and a plurality of requested terms in response to the renewal indication, receiving one of more bid responses, and generating a contract by incorporating information from a previous contract and one of the responsive bids. The contract renewal indication may be associated with the expiration of a prior contract, and may comprise instructions from a user to initiate a new contract. In addition, the bids may be scored according to a predetermined scoring standard, one of the responsive bids may be selected from which the new contract is formed, and the highest scoring bidder may be the one selected for the new contract.

### BACKGROUND

This invention relates to automated contract generating systems, and more particularly to systems and methods for generating contracts in a recurrent contracting environment.

It used to be that you could close a deal with a handshake. Communities were small, neighbors dealt with neighbors, friends dealt with friends. You worked out the deal face-to-face. The transactions were simple. You had time. You relied on honor. You relied on common sense. That was then.

The global marketplace is enormous. People do business across the country or around the world—with complete strangers. They don't meet the other party, they probably don't see the other party, and they might not even talk to the other party. The deals are complex with numerous terms. Time is money. You rely on the law. You rely on contracts. This is now.

But contracts are in fundamental conflict with speed-of-light commerce. They require negotiation. They have to be typed up. They have to be revised, and renegotiated. They have to be copied, signed, and exchanged. The contract negotiation and approval process can be made more efficient by making the documents electronic so that, for instance, drafts are exchanged by e-mail, with red-lined comments indicating each party's suggestions. Still, this process takes significant personal involvement, so that the overhead of consummating a deal can become a significant cost of the deal itself.

The overhead cost of contracting can be particularly problematic for recurring contracts, which are redone repeatedly over time. For example, a large corporation may have a number of purchasing contracts that it renews on a periodic basis, such as once a year, or for a particular project or a particular unique, through recurring, need. The contracts may cover the provision of office supplies, janitorial services, or utility services. Although it is possible to have the contracts run for a long time period or simply to extend a contract so as to avoid the cost of reletting the contract, the parties may want to be able to receive competing bids on a new contract to make sure they are getting the best deal possible.

Certain approaches to contracting can remove the human element required to negotiate a new contract, and can thus result in lower transaction costs. One option is the adhesion contract. In such a contract, one party picks the terms, and provides them to the other party as a take-it-or-leave-it proposition. For example, the terms may be listed on the back of an order form or an invoice. Such a system is simple and easy to administer. There is no negotiating and essentially no flexibility. Adhesion contracts are typically used in retail establishments and for some automated transactions, for example, with “click wrap” agreements. Because there is no negotiating, the subtleties of human behavior play little or no role, and such transactions can be automated very easily.

Thus, while such an approach makes it easy to contract repeatedly in a recurring contract environment, it allows little or no customization of a particular contract. Thus, there is a need for contractual formation that is flexible yet low in cost.

### SUMMARY

This document discloses a method and system that assists in creating contracts by combining pre-existing information with information provided by the contracting parties. In one aspect, a system for generating contract documents in a recurring contracting environment is disclosed. The system comprises contract storage that maintains information relating to a previous contract that has been entered into, a bid invitation generator associated with a buyer, an interface that provides the bid invitation to one or more designated bidders and receives responsive bids from one or more of the designated bidders, and a contract generator configured to form a new contract based on the information relating to a previous contract and one of the responsive bids. The bid invitation generator is adapted to convert the information relating to a previous contract into basic bid invitation information, and to provide supplemental bid invitation information in the form of a bid invitation.

The bid aggregator may be configured to score the bids according to a predetermined scoring standard, the contract generator may select the one of the responsive bids from which the new contract is formed, and the highest scoring bidder may be selected for the new contract. In addition a bid trigger may be provided to cause the bid invitation generator to generate a bid invitation upon the occurrence of the pending expiration of a prior contract or upon the meeting of a target quantity on a prior contract. The contract generator may also form a portion of the new contract based on previously agreed upon terms between the buyer and a selected bidder, or on provisions selected by the buyer during performance of a prior contract.

In some embodiments, the bid invitation may offer a plurality of selectable provisions associated with a contract clause. In addition, a bid aggregator may be provided to generate a summary of terms from the responsive bids. The system interface may also supervise contracting workflow to allow for approval of the new contract, and the contract generator may form the information relating to a previous contract by extracting terms from a prior contract. The bid invitation may also be provided in the form of a term sheet.

In yet another embodiment, a computer-implemented method of generating contracting documents is disclosed. The method comprises receiving a contract renewal indication, generating a bid invitation having a plurality of offered terms and a plurality of requested terms in response to the renewal indication, receiving one of more bid responses, and generating a contract by incorporating information from a previous contract and one of the responsive bids. The contract renewal indication may be associated with the expiration of a prior contract, and may comprise instructions from a user to initiate a new contract. In addition, the bids may be scored according to a predetermined scoring standard, one of the responsive bids may be selected from which the new contract is formed, and the highest scoring bidder may be the one selected for the new contract.

In certain embodiments, the generation of a bid invitation may be triggered upon the occurrence of the pending expiration of a prior contract, or upon the meeting of a target quantity on a prior contract. The new contract may also be formed based on previously agreed upon terms between the buyer and a selected bidder, or on provisions selected by the buyer during performance of a prior contract. In addition, the bid invitation may offer a plurality of selectable provisions associated with a contract clause, and a summary of terms from the responsive bids may be generated.

In other embodiments, contracting workflow may be supervised to allow for approval of the new contract, and the information relating to a previous contract may be formed by extracting terms from a prior contract. Also, the bid invitation may be provided in the form of a term sheet.

Advantageously, the method and system may provide effective automation for the contract negotiation process so that additional contracts may be let for a proportionately lower cost, while maintaining flexibility to negotiate the contracts.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram showing the operation of a recurring contracting cycle in accordance with the present invention.

FIG. 2 is a schematic diagram of a system capable of carrying out a recurring contract formation process.

FIG. 3 is a block diagram of a system for managing contract formation.

FIG. 4 is a flow chart showing the interaction of an automated contracting system with the users of such a system.

FIG. 5 is a listing of contract provisions that may be passed to a bid invitation and passed from a resulting bid.

FIG. 6 is a screen shot of a display for processing bid invitations that may be provided to prospective bidders.

FIG. 7 is a display for selecting a contract from among available contracting information.

FIG. 8 is a display for creating a contract by specifying certain general contract parameters.

FIG. 9 is a display for creating a contract by specifying certain specific contract parameters.

Like reference symbols in the various drawings indicate like elements.

### DETAILED DESCRIPTION

FIG. 1 is a schematic diagram showing the operation of a recurring contracting cycle 10 in accordance with the present invention. Cycle 10 can represent, for example, a recurrent bidding and contracting process for business supplies, by which a company enters a one-year contract for supplies, and subsequently seeks another one-year contract through an open bidding process. Node 12, designated “A,” in the cycle represents the occurrence of a contract renewal condition. For example, node 12 may represent the imminent expiration of a previous contract, wherein lead time is built into the notification so that a new contract may be let and negotiated before the expiration of the previous contract. The event that triggers the renewal may also be, for example, the imminent meeting of a quantity target on a prior agreement, or the release of a new specification for a product or service, so that a new contract will be needed in the near future. Node 12 may also represent the selection by a user to start the bidding and contracting process on a new contract, or to extend or otherwise alter the terms of a prior contract.

Upon a determination that a new contract should be negotiated, a bid invitation may be prepared as indicated by node 14, designated “B.” As explained in more detail below, the bid invitation may contain terms culled from a preexisting contract, such as the contract shown from the previous cycle at node 18, designated “D,” where the contracts are entered in a recurring fashion. Alternatively, the prior contract from which the terms are taken could be a form contract or another available contract containing terms that are desired to be placed in the intended contract. Although the term “contract” is used to describe the pre-existing document from which certain terms may be taken, the contract does not have to be a formal, written contract like the contracts that are signed to close a deal. Rather, the contract may consist of a number of associated contract terms and/or contract provisions arranged in any number of ways as will be understood by a skilled artisan.

The terms and provisions that are taken from the document to be presented to bidders may be referred to as offered terms. For example, the organization seeking bids may have a particular product specification or description that it wants bidders to match, without substantial variance or negotiation. In addition, the organization may have certain contract provisions, such as warranty, arbitration, and choice of law provisions, that it wants in each contract. Other terms may be left open and may be requested from the bidders. Typically, price is such a term, and may include complex pricing schemes in which pricing is affected by quantities ordered (e.g., in a stepped fashion, with price decreasing for increasing quantities), by the location in an organization to which goods must be delivered, and by other relevant factors. The bid invitation may leave the price term entirely open, may include structural limits on price such as pricing points for various quantities, or may even leave price closed and provide price as an offered term.

The bid invitation may also provide offered terms that are somewhat open. Specifically, bidders could be provided with several provisions for a particular part of a contract, and they may be allowed to select the one provision that they prefer. As one example, bidders may be provided with several options for delivering goods (e.g., Federal Express overnight, UPS, DHL, and regular mail), and may select one option, with their bid to be judged according to the option selected. In this manner, the bidder may attempt to balance the various terms in a manner that it believes will give it the highest chance of winning the bid and still making money on the contract.

Once the bid invitation has been assembled, it may be sent to potential bidders, including the supplier on any current contract or contracts, and to additional new suppliers. The suppliers may be identified by any appropriate known means, such as by industry-specific lists or manually by the relevant procurement officer. In addition, the bid invitation may be presented to the potential bidders in any appropriate manner, such as by e-mail, facsimile, by appropriately formatted XML document, or by posting on an available Internet web site that allows interaction by the bidders.

An appropriate period may then be allowed for the bidders to enter their bids. The bids may consist of more than simple price terms, and may include items such as the currency for the transaction, complex bidding structures (e.g., based on various quantities, combinations of items ordered, and locations for delivery of the items, and discounts), and additional provisions, not contemplated by the bid invitation, that are added by a particular bidder. In addition, where multiple optional provisions for a contract are offered by the buyer in the bid invitation, the bidder may select one of the provisions, such as by selecting an on-screen radio button or other appropriate mechanism.

The bids may be submitted by the bidders over the open bid period, and may be compiled by a central system operated by the buyer or by a third-party, as shown by node 16, designated “C.” Reports may be generated from the bids to assist the buyer is assessing the bids. For example, various terms provided by the bidders could be displayed in a chart for side-by-side comparison. From such a comparison, the buyer or an automated system operated under the buyer's specifications, can select a bidder with which to proceed under a subsequent contract.

The buyer's system may then create a subsequent contract from a combination of the prior contract and the bid information. In a simple example, requested terms provided by the selected bidder may be inserted into appropriate fields in the contract. Much more complicated options are also available. For example, contract provisions may be selected from various lists of provisions based upon selections that the winning bidder made from options provided in the bid invitation. Also, where the buyer and the winning bidder have an ongoing relationship, they may have certain agreed-upon provisions for all of their contracts (which may be specified in a separate agreement). Those provisions may be added to the constructed, subsequent contract and may replace other corresponding provisions in the prior contract. Thus, provisions for the subsequent contract may be obtained from a variety of sources, including the bid invitation, the winning bid, the prior contract, and agreed-upon terms between the parties.

Once the contract is formed, it may be released to an approval workflow, as shown by node 18, designated “D.” The approval workflow may be only unilateral, occurring among members of the buying organization. Alternatively, it could be bilateral, with participation by the selected bidder. The workflow may allow only approval or disapproval, or it may allow users to may changes to the contract, which may then be voted upon and accepted or rejected by the other party. When the contract is final and has been agreed upon, it can be approved and made binding by any appropriate means, including by printing and signing a hard copy, by digital signatures, or by other known means.

Thus, by this process, a subsequent contract may be easily and flexibly formed from a prior contract in a recurring contract situation. Content from the subsequent contract may come from a variety of sources, so as to meet the needs of the parties. For example, where the parties want little involvement in the contracting process, they can provide a minimal number of contract terms, and the remaining terms and provisions may be supplied by pre-established contracts. Alternatively, where the deal is more complex so that additional flexibility is needed to allow the parties to customize their agreement, the system allows such customization.

FIG. 2 is a schematic diagram of a system 30 capable of carrying out a recurring contract formation process. The system 30 may be managed by a member of an organization, such as a procurement officer, who accesses system 30 via terminal 34, which may be any appropriate mechanism to access system 30, such as a web-browser equipped personal computer, a personal digital assistant, or other device. Terminal 34 may connect to network 32, which may be a local area network (LAN) or wide area network (WAN) operating within a particular organization, such as over an intranet or portal system. In this manner, terminal 34 may have access to contract information stored in structured database 38 and unstructured database 40. Structured database 38 may include, for example, one or more relational databases that reflect quantities of goods purchased by the organization and prices paid for those goods, and may be, for example, an SAP data warehouse. System 30 may supply values for entries in structured database 38, such as by inserting a contracted-for amount as a cost of goods entry. Such an entry may then be used by other components in communication with network 32, such as other components of a enterprise resource planning (ERP) system. System 30 may also read entries out of structured database 38, such as to determine the number of a particular item in inventory and the demand for that item over time. Unstructured database 40 may include items, such as documents and digitized audio and video files, that do not fit easily into a structured database, and may be, for example, an SAP knowledge management (KM) database.

Information relating to the system may be delivered by web application server (WAS) 36, including over link 42 to the Internet 44. In this manner, users such as bidders external to the organization may communicate with the user at terminal 34 and may access bid invitations and other necessary contracting information. For example, terminals 46, 48 may have e-mail access or may contain web-enabled browsers that allow users to access bid invitations and respond to them electronically. Other devices, such as a wireless personal digital assistant 50, may also communicate with WAS 36.

As will be understood, system 30 is simply an example of one form by which access may be provided to a system for managing contract information and formation. Many other configurations are readily possible.

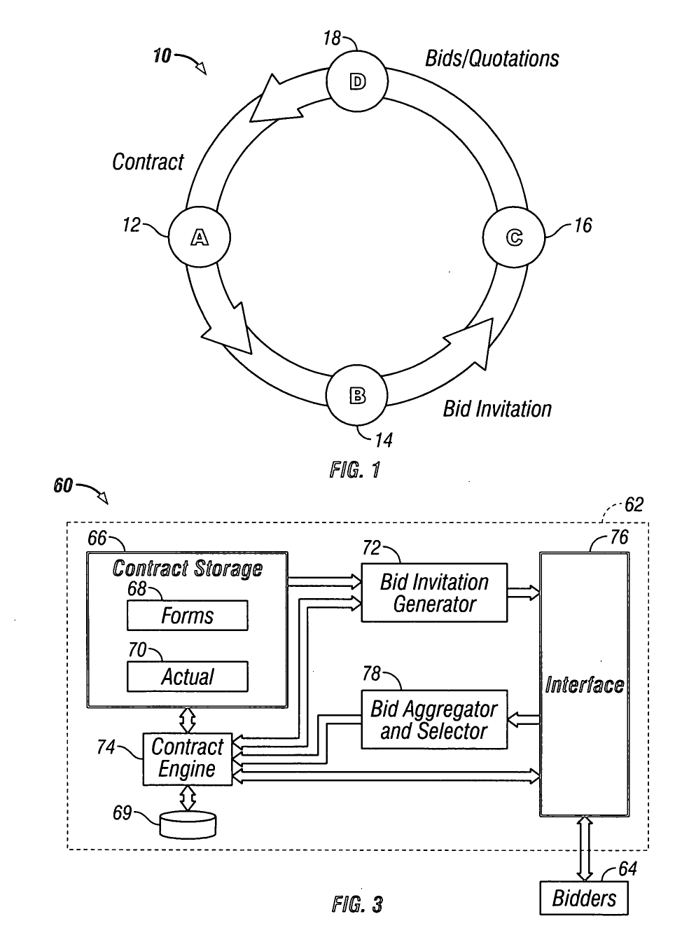

FIG. 3 is a block diagram of a system 60 for managing contract formation. The system 60 is comprised of elements controlled within one organization, indicated by dashed box 62, which communicate with various bidders 64 through interface 76. Interface 76 may be any appropriate mechanism or mechanisms for communication, such as via e-mail, XML messages, various standards for web page interaction, facsimile, or other means.

Contracting information is accessible from contract storage 66, both as forms 68 and actual contracts 70. Forms 68 may be typical form contracts containing contracting provisions and locations at which particular information, such as the names of the parties, the length of the contract, and other terms, may be added. Forms 68 may also comprise various contract provisions that can be assembled in an ordered manner so as to create a contract. Actual contracts 70 may simply be text files of contracts that have previously been entered into by the organization. Alternatively, actual contracts 70 may be aggregated provisions that are capable of making up a completed contract, such as blank provisions that are associated with terms needed to fill in those provisions. The actual contracts 70 may also comprise attachments and addendums for the contracts themselves. The actual contracts 70 may be associated with identification numbers to aid in their organization and access, for example, to allow the system to locate a prior contract when a subsequent contract needs to be produced. Both forms 68 and actual contracts 70 may be stored and organized in any appropriate manner, including as entries in one or more databases.

Bid invitation generator 72 may draw upon the existing forms 68 and actual contracts 70 in contract storage 66 in producing a bid invitation to be sent out to bidders for a subsequent contract, when a prior contract is about to expire. Bid invitation generator 72 may, for example, access the prior contract, strip it of transaction-specific information that applies only to the prior contract, and generate bid terms from the remaining information, along with other information that may be provided by the system 60. For example, a purchasing officer may have specified a new term for the contract, new quantities, revised provisions, or other items that should be changed between the prior contract and the subsequent contract. Specifically, the officer may have determined that, because of changes in business conditions, the subsequent contract should have a longer term than the prior contract, or that demand exceeded the prior contract so that the subsequent contract should anticipate a larger volume than the prior contract.

Bid invitation generator 72 may also incorporate information generated by a user during performance of the prior contract. For example, where difficulties arose in the performance of the prior contract, the user may have indicated such difficulties to the system, and may have provided notes regarding those difficulties. Thus, the bid invitation generator 72 may present the user with those notes before the bid invitations are transmitted. Also, the user may have had the opportunity, when those earlier problems arose, to select from among alternative available provisions, and the selected provision could be inserted in the bid invitations and also used in the subsequent contract. With this feature, the user may be able to address and correct problems from the prior contract without having to catalogue and remember them at the time of contract renewal.

Bid invitation generator 72 may pass information received from contract storage 66 on as part of the bid invitation and may alternatively, or in addition, convert the information to a format appropriate for a bid invitation. For example, the verbiage of a contract may be replaced with a more compact term sheet that provides summaries of the relevant provisions. In addition, access to the bid invitation may be provided to contract engine 74, which may comprise an automated application or simply an editor made available to a user through a computer terminal. Thus, once a preliminary bid invitation has been generated, the contract engine 74 may provide the opportunity to review the preliminary invitation and make changes to it. For example, a purchasing agent may prefer to review the prior contract and any other information relating to the performance of that contract before sending out a new bid invitation. Specifically, the agent may change the identification or specification for items to be provided under the contract if members of the organization expressed dissatisfaction with the items supplied under the prior contract.

The bid invitation may be generated so as to create multiple options for certain terms or provisions. For example, bidders may be provided with several options by which they can choose to ship products under the contract, wherein some options are more expensive than others. The bidders may then select one of the options with the understanding that it might help or hurt their chance of winning the bid. The buyer may institute bid evaluation rules to help determine the overall effect of various terms from various bidders on the quality of the bid. For example, a scoring system may be constructed by which various terms have an assigned importance relative to other terms, and the values that are bid for each term may be normalized so as to provide a convenient mechanism to evaluate the bids. For example, a bidder may be given several options for providing delivery, with the understanding that, by selecting a less expensive option, the bidder's chance of getting the contract will be hurt. In a like manner, various product specifications may be provided, and the bidder could choose the level of quality that it would like to provide. The bidders may also be made aware of the scoring rules so that they can evaluate the various options available to them under a bid invitation.

Once a bid invitation has been fully generated, it may be made available to bidders through interface 76. Interface 76 may be any appropriate system, such as an e-mail system or a web application server. Interface 76 may allow interaction with bidders 64 using any of a number of appropriate mechanisms. Bidders to be targeted by a bid invitation may be selected by the user, or may be selected automatically such as by accessing lists of possible suppliers in a particular industry. For example, if the prior contract was performed in an unsatisfactory manner, the company on that contract may be excluded from the bid list for the subsequent contract, either by the user or automatically, such as by checking or evaluating a satisfaction rating associated with the bidder's performance.

Bid aggregator and selector 78 receives bids that are returned by bidders in response to the bid invitation. Important requested provisions or terms that were obtained from the various bidders may be compared by the bid aggregator and selector 78, either by placing them in a convenient format so that a user can review them, or by an automated selection process. As an example, a grid of selection criteria may be presented to a user along with the corresponding terms presented by each bidder, and the user may be allowed to select the preferred bidder, which then becomes the other party to the subsequent contract. Alternatively, the system may review the bids to determine which bids meet minimum standards, and then select the bidder from that group with the lowest price. In addition, the bid aggregator and selector 78 may initially remove any bidders that do not meet minimum bidding requirements, so that such bidders are not even included in the evaluation process.

Bid aggregator and selector 78 may then pass information about the winning bidder to contract engine 74. The information may include values for certain provisions in the contract (e.g., price, term, etc.), and may also include additional information provided by the winning bidder. Other information needed to complete the contract may be obtained from a variety of sources. For example, the basic language for the contract may be accessed from contract storage 66. The contract engine 74 may obtain an identifying number for the bid and may use that number to access the appropriate information from contract storage 66.

The contract engine then aggregates the appropriate information from contract storage 66, and obtains the remaining information from the winning bidder via bid aggregator and selector 78. Additional data can be accessed from database 69 or from other data storage sources, for example, data relating to other contracts between the parties, detail information about the goods, and other information required to produce a complete contract that is ready for execution.

Once the provisions and terms have been assembled, contract engine 74 provides the user with additional opportunities to review the draft contract, and make final changes. If the draft contract meets with approval, contract engine 74 may then distribute the contract via interface 76 to the winning bidder and to others who need to review the contract, such as through a managed workflow process. For example, the winning bidder may be given an opportunity to make small changes to the contract, which the drafter of the contract could then review and accept, edit, or reject. Although system 60 allows for manual alterations to the contract, such access is not required, as in some situations, a contract could easily be assembled and approved without human intervention, particularly when the parties have entered numerous contracts with each other and have an ongoing relationship.

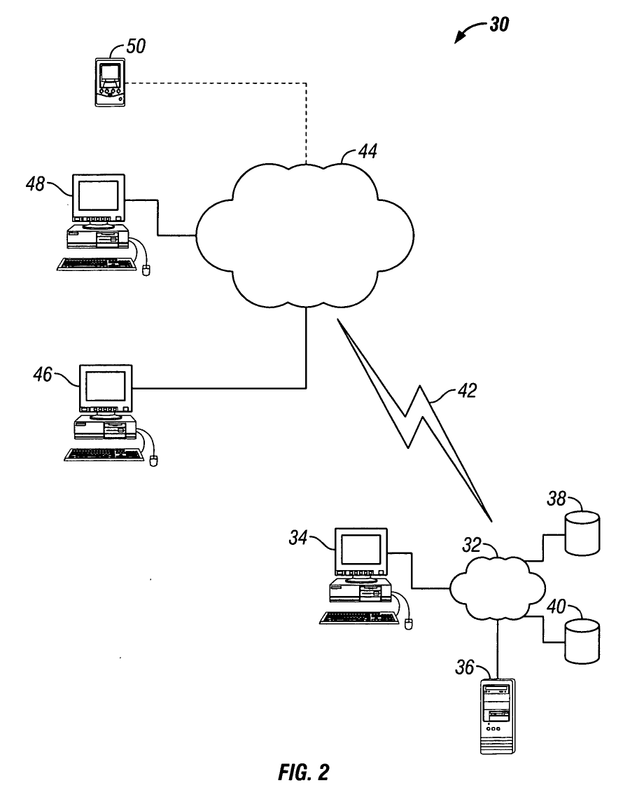

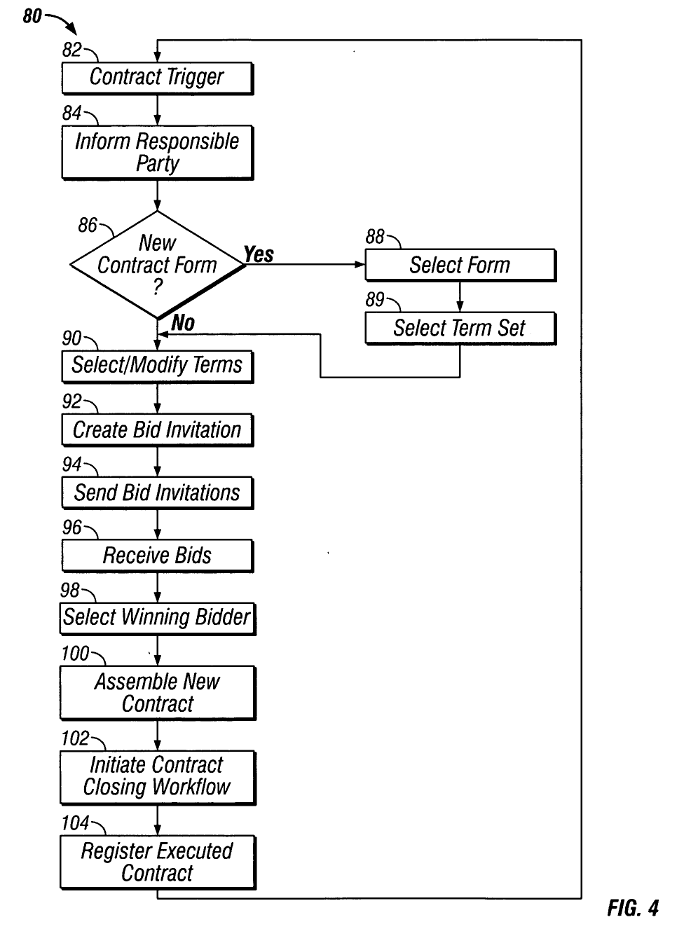

FIG. 4 is a flow chart showing the interaction of an automated contracting system with the users of such a system. The system initially begins the processing of a new (or subsequent) contract upon the generation of a contract trigger (box 82). The trigger could be generated by a user who wishes to prepare a new contract, or it may be generated when the system computes that a prior contract is nearing the end of its life, and a new contract will soon be needed. Where the trigger is automatically generated, the person responsible for a subsequent replacement contract can be notified (box 84) to determine whether a follow-up contract will be required. The user may then be prompted as to whether the prior contract will be used to generate the subsequent contract, or whether a new contract or other materials will be used (box 86). For example, where the prior contract was not satisfactory or the user has used another contract that seems to have performed better, the user may select to use the different contract. If the user selects a new contract, the system may then (at box 88) allow the user to select the new contract, such as by selecting a form contract from a list, by identifying a contract for another matter, or by assembling a number of available provisions to generate a contract. As part of the form selection or separately, the user may also select the terms (box 89) that will be requested of the bidders.

If the user is satisfied with the prior contract and wants to recycle it for the pending work, then the form for the existing contract is accessed. Whether the old contract form or a new contract form are selected, the user may then select or modify the terms and provisions of the contract before any information is sent to the bidders (box 90). In particular, the user may want to add additional favorite clauses that are not supported by any of the existing or form documents. Although the user may work on the actual contract itself, they may also simply edit particular terms that need to be identified so that bidders can make informed bids, and particular details of any contract may be worked out later, particularly where the terms and provisions are fairly standard.

When the terms are satisfactory to the user, a standard bid invitation may be generated (box 92). The bid invitation may contain identifying information in addition to information that describes the type of goods or services sought to be purchased, the manner is which the purchase and delivery is to be made, the expected quantity demanded, and the term of the agreement if such a term is desired to be specified. The bid invitation may leave open relevant terms, such as price, delivery methods, term, and price breakdowns (e.g., price at various levels of quantity demanded), and make these requested terms from the bidders. The user may also edit the bid invitation before sending it out.

When the bid invitation is in adequate form, it may be sent to the desired bidders (box 94). The bid invitation may include all materials needed for the bidders to respond, or may simply contain enough information to allow the potential bidders to seek further information. For example, the bid invitation may be an e-mail containing a uniform resource locator (URL) that a targeted bidder may click to be taken to a web site that allows a review of the proposal, and also allows the bidder to respond with the necessary requested terms. Such a system may allow for more control and security over the bidding process. The bidding procedure may in general proceed using standard supplier relationship management (SRM) tools and techniques.

The user may specify a period in which to receive bids, and responses from various bidders may be received throughout this period (box 96). At the close of the bidding period, the bid may be checked against bidding criteria, and ineligible bidders may be removed from consideration. Also, each bid may be audited to determine if it is sufficiently complete. Incomplete bids may be sent back so that the bidder may complete them, or may simply be rejected, with the bidder taken out of consideration. Alternatively, if the bids are submitted on-line, the system may notify the bidder that the bid is incomplete when the bid is submitted. When all eligible bids are identified, they may then be aggregated in a manner that allows the system or the user to compare the bids so as to select the best bid (box 98).

Upon the selection of a winning bidder, the system may take the necessary steps to assemble a new contract (box 100). For example, the system may replicate the terms and provisions of the prior contract (but by removing terms specific to that particular contract), and may add information specific to the winning bidder and the winning bid, such as the information received from the winning bidder, and information that the system may have already associated with the winning bidder (such as name, address, and other terms). The system may also attach relevant materials, such as specifications or exhibits of particular products that may be referenced from within the contract. These materials may be obtained, or may have been obtained, from the system, from the winning bidder, or from another appropriate location. The resulting draft contract may also be edited by the user, typically to make small changes in the particular contract language.

Once the contract is in a satisfactory form, contract closing workflow may be initiated (box 102). As a result, the contract may be sent to appropriate approval authorities within the present company, such as purchasing managers or supervisors, who may be given the ability to veto the purchase. At the same time, subsequently, or even before, the contract may be transmitted to the winning bidder. Standard workflow parameters and tools may enable the parties to negotiate further terms of the contract to the extent necessary, and to agree on and sign a final contract. In addition, the contract may be provided with an appropriate identifier and may be saved and registered (box 104) so that the contract may serve as the “previous” contract the next time the user passes through the contracting cycle. In addition, various properties from the agreement can be provided to the remainder of the system. For example, the term of the contract may be provided to a docketing system that will remind the user when the contract needs to be renegotiated, and the prices of the contract may be placed in a database to be used for budgeting, accounting, and other similar purposes.

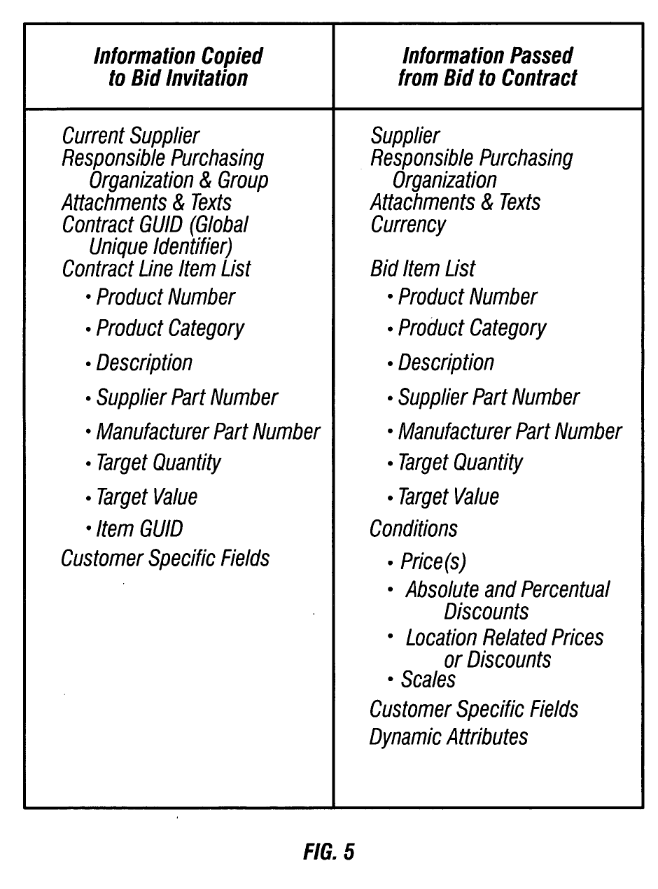

FIG. 5 is a listing of contract provisions that may be passed to a bid invitation and passed from a resulting bid. The lists are simply examples, and other information may also or alternatively be passed at each phase of the contracting cycle.

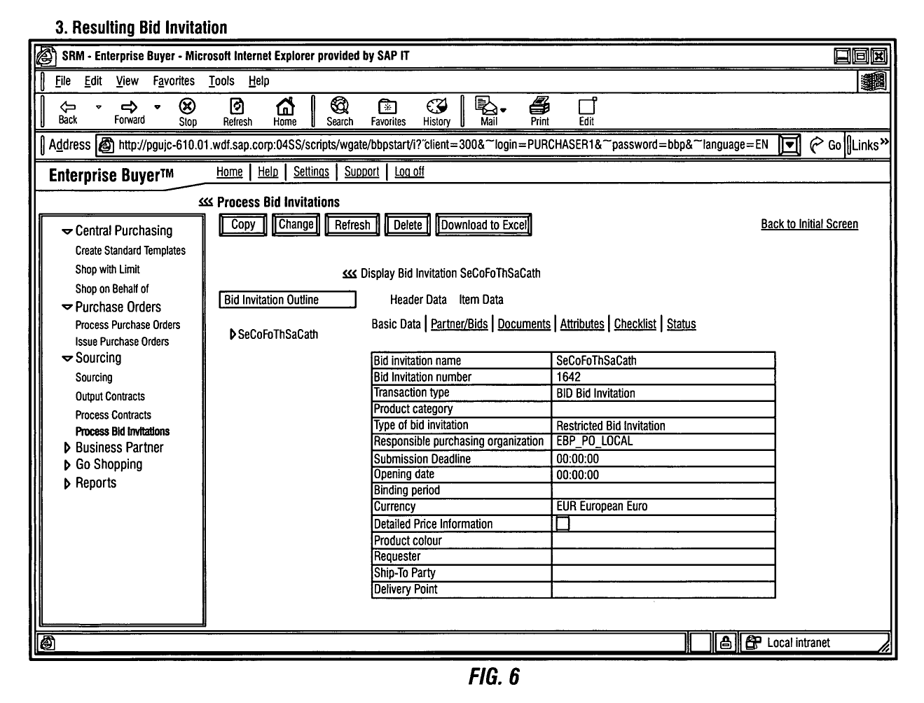

FIG. 6 is a display for processing bid invitations that may be provided to prospective bidders. As shown, access is provided to the system through a standard web browser. The displayed page shows basic data relating to a bid invitation. As shown, basic header data can be specified, including a name and number for identifying the bid invitation, the type of the transaction and the bid invitation, the product category and responsible purchasing organization (whether a particular organization or a group within the organization), the opening and closing (submission deadline) of the bidding period, the binding period, the currency in which bids are to be made, and information regarding the product and its shipping.

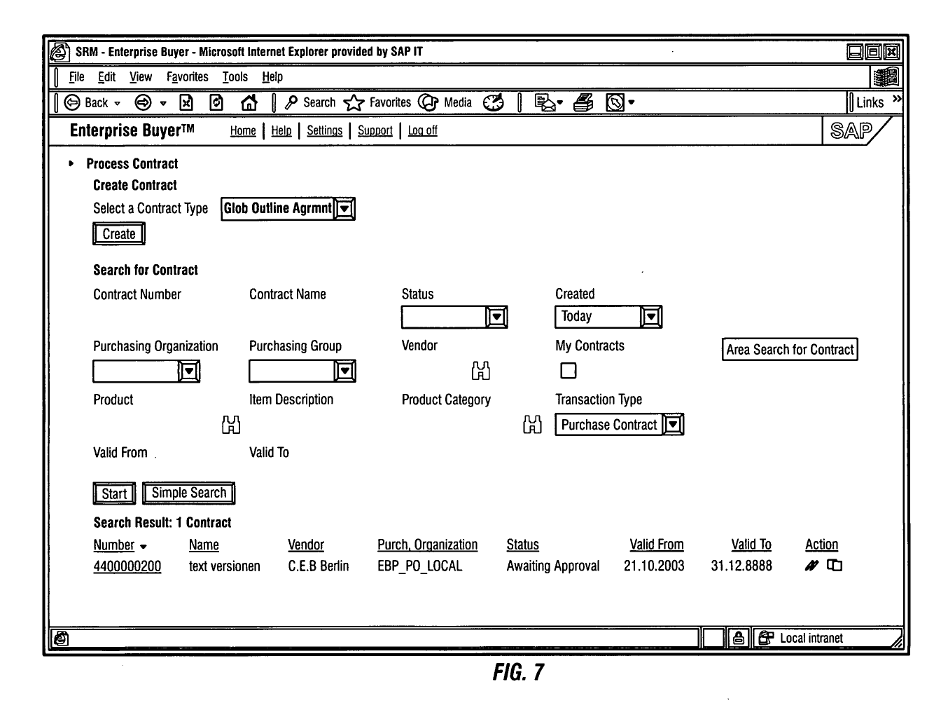

FIG. 7 is a display for selecting a contract from among available contracting information. The display allows for creating a contract from preexisting general contract types or searching for a specific contract that has previously been created. A contract may be created by selecting a contract type from a drop-down box that lists a number of different contract types. These contract types may be provided by the system, and users may be allowed to add additional contracts to meet their specific needs. Once a contract type is selected, the user may select a “create” button to form the contract. Alternatively, a user could create a contract from a number of preexisting components according to the user's specific needs, or could create or locate a contract by other appropriate mechanisms.

Tools are also provided to allow a user to search for a preexisting contract. For example, the user may enter the contract number or name, if it is known. The user may also provide broader categories of search information, such as contract status, a date range for the creation of the contract, the organization that is purchasing goods or services under the contract, the purchasing group responsible for the contract, the vendor providing goods or services under the contract, the products covered by the contract or descriptions or categories of those products, or the type of the transaction. Also, the user may choose to have displayed each contract with which that user is associated.

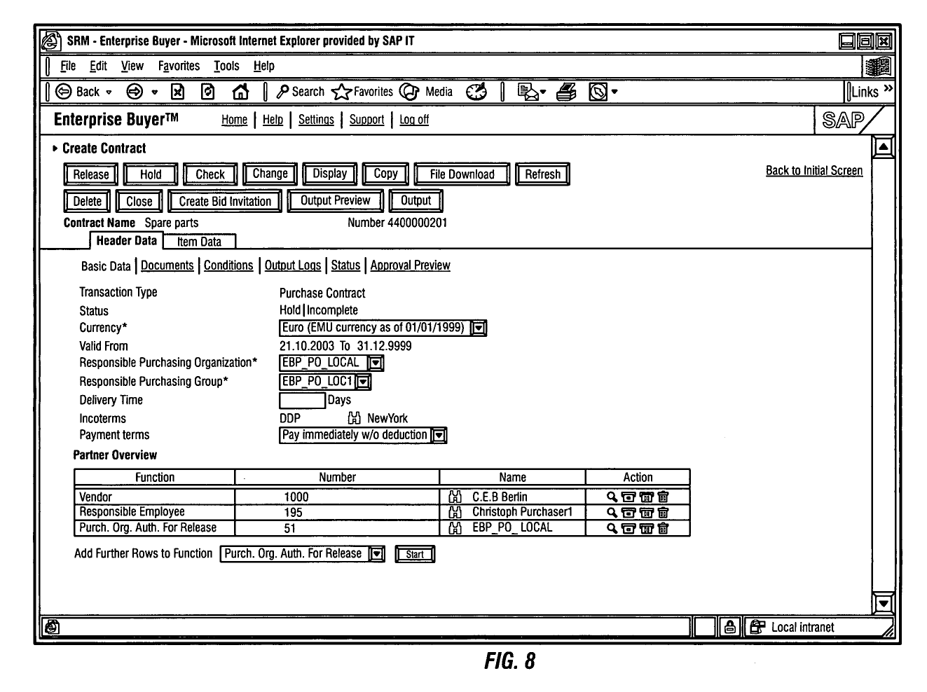

FIG. 8 is a display for creating a contract by specifying certain general contract parameters. A number of contract control buttons are provided at the top of the display to allow downloading of contract information, holding an in-progress contract, checking a contract, refreshing a contract with newly added terms, deleting a contract, and previewing a contract based on parameters already entered or selected. For reference, the contract name and a unique contract identifying number are provided. Basic general information for the contract, termed “header data,” is provided, and specifically “basic data” is shown in the display. The data may include the type of transaction, the status of the contract, the currency in which payment under the contract is to be made, the term of the contract, the organization and purchasing group responsible for the contract, the time allowed for delivery, the incoterms, and the payment terms. In addition, where a partner for the displayed contract has been previously selected or otherwise determined, information about the partner, including identification information, may be displayed.

Other header data may be shown on other displays. For example, documents corresponding to the contract may be listed or described, and may include internal notes concerning the contract (such as notes made by a purchasing agent during the formation or execution of the contract), and attachments to the contract. Provision may be made in any of a number of well-known manners for a user to create such attachments or to associate the contract to a file (such as a word processing document) that will serve as the attachment. Also, conditions associated with the contract may be specified; for example, discounts may be specified for certain times during performance of the contract, or for certain quantity levels under the contract. Output logs may also be displayed, and may comprise documents that have been created using the contract information. For example, particular generated contracts may be listed, along with information identifying their creation dates, means of creation, document type, and document number. Status information may also be provided to show where a contract is in its formation and/or performance process, an approval preview may be provided to identify users who are part of the contract approval process, and whether they have or have not yet approved the contract. Finally, a listing of various versions of the contract information may be provided, with the time of creation for each version, and the ability to recall each version.

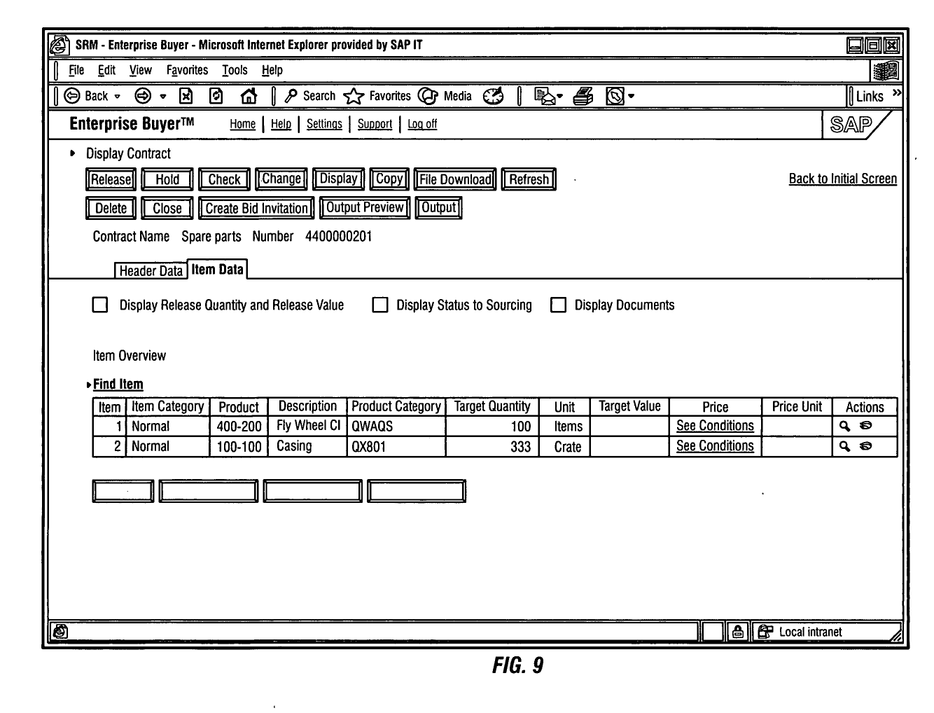

FIG. 9 is a display for creating a contract by specifying certain specific contract parameters. In particular, specific items for a particular purchasing contract may be set out, along with product numbers, descriptions, and categories, and target quantities and/or values for the contract. Functionality may be provided to allow a user to add, remove, and edit items, and to search for and identify items for the list. Each item may also be selected so as to provide the user with a more detailed listing of the item parameters. Various parameters may be used as necessary to allow adequate management and tracking of products and the contracting process.

As used herein, the terms “electronic document” and “document” mean a set of electronic data, including both electronic data stored in a file and electronic data received over a network. An electronic document does not necessarily correspond to a file. A document may be stored in a portion of a file that holds other documents, in a single file dedicated to the document in question, or in a set of coordinated files.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. A number of embodiments of the invention have been described. Nevertheless, it will be understood that various modifications may be made without departing from the spirit and scope of the invention. For example, the various steps shown in FIG. 4 may be omitted or rearranged, and other steps may be added to the process. Also, the particular components of FIG. 3 may be supplemented and rearranged, and their functions may be combined or carried out by different components. Accordingly, other embodiments are within the scope of the following claims.

1. A system for generating contract documents in a recurring contracting environment, comprising:
contract storage that maintains information relating to a previous contract that has been entered into;
a bid invitation generator associated with a buyer and adapted to convert the information relating to a previous contract into basic bid invitation information, and to provide supplemental bid invitation information in the form of a bid invitation;
an interface that provides the bid invitation to one or more designated bidders and receives responsive bids from one or more of the designated bidders; and
a contract generator configured to form a new contract based on the information relating to a previous contract and one of the responsive bids.

2. The system of claim 1, further comprising a bid aggregator configured to score the bids according to a predetermined scoring standard.

3. The system of claim 2, wherein the contract generator selects the one of the responsive bids from which the new contract is formed.

4. The system of claim 3, wherein the highest scoring bidder is selected for the new contract.

5. The system of claim 1, further comprising a bid trigger that causes the bid invitation generator to generate a bid invitation upon the occurrence of the pending expiration of a prior contract.

6. The system of claim 1, further comprising a bid trigger that causes the bid invitation generator to generate a bid invitation upon the meeting of a target quantity on a prior contract.

7. The system of claim 1, wherein the contract generator forms a portion of the new contract based on previously agreed upon terms between the buyer and a selected bidder.

8. The system of claim 1, wherein the contract generator forms a portion of the new contract based on provisions selected by the buyer during performance of a prior contract.

9. The system of claim 1, wherein the bid invitation offers a plurality of selectable provisions associated with a contract clause.

10. The system of claim 1, further comprising a bid aggregator adapted to generate a summary of terms from the responsive bids.

11. The system of claim 10, wherein the interface supervises contracting workflow to allow for approval of the new contract.

12. The system of claim 1, wherein the contract generator forms the information relating to a previous contract by extracting terms from a prior contract.

13. The system of claim 1, wherein the bid invitation is provided in the form of a term sheet.

14. A computer-implemented method of generating contracting documents, comprising:
receiving a contract renewal indication;
generating a bid invitation in response to the renewal indication, the bid invitation including a plurality of offered terms and a plurality of requested terms;
receiving one or more bid responses; and
generating a contract by incorporating information from a previous contract and one of the responsive bids.

15. The method of claim 14, wherein the contract renewal indication is associated with the expiration of a prior contract.

16. The method of claim 14, wherein the contract renewal indication comprises instructions from a user to initiate a new contract.

17. The method of claim 14, further comprising scoring the bids according to a predetermined scoring standard.

18. The method of claim 17, further comprising selecting the one of the responsive bids from which the new contract is formed.

19. The method of claim 18, further comprising selecting the highest scoring bidder for the new contract.

20. The method of claim 14, further comprising triggering the generation of a bid invitation upon the occurrence of the pending expiration of a prior contract.

21. The method of claim 14, further comprising triggering the generation of a bid invitation upon the meeting of a target quantity on a prior contract.

22. The method of claim 14, wherein a portion of the new contract is formed based on previously agreed upon terms between the buyer and a selected bidder.

23. The method of claim 14, wherein a portion of the new contract is formed based on provisions selected by the buyer during performance of a prior contract.

24. The method of claim 14, wherein the bid invitation offers a plurality of selectable provisions associated with a contract clause.

25. The method of claim 14, further comprising generating a summary of terms from the responsive bids.

26. The method of claim 25, further comprising supervising contracting workflow to allow for approval of the new contract.

27. The method of claim 14, further comprising forming the information relating to a previous contract by extracting terms from a prior contract.

28. The method of claim 14, wherein the bid invitation is provided in the form of a term sheet.
